(19) United States
(12) Patent Application Publication
(10) Pub. No.: US 2026/0147216 A1
(43) Pub. Date: May 28, 2026

(54) COMPACT ILLUMINATION SYSTEM WITH IMPROVED OPTICAL PERFORMANCE

(71) Applicant: Lumus Ltd., Ness Ziona (IL)

(72) Inventor: Eitan RONEN, Rechovot (IL)

(73) Assignee: Lumus Ltd., Ness Ziona (IL)

(21) Appl. No.: 19/100,154

(22) PCT Filed: Oct. 19, 2023
(86) PCT No.: PCT/IB2023/060578

§ 371 Date: Jan. 31, 2025

Related U.S. Application Data
(60) Provisional application No. 63/424,921, filed on Nov. 13, 2022.

(51) Int. Cl. G02B 27/01; G02B 27/10; G02B 27/28

(52) U.S. Cl. CPC G02B 27/0176; G02B 27/0172; G02B 27/1026; G02B 27/283; G02B 27/286; G02B 2027/015; G02B 2027/0161

(57) ABSTRACT

An optical device may include a first and second polarization-selective surfaces, each configured to reflect a first polarization of incident light and transmit a second polarization of incident light orthogonal to the first polarization, the first polarization-selective surface disposed between first and second optical input surfaces at a first angle α relative to an optical axis of the device and the second polarization-selective surface disposed between the first and second optical input surfaces at a second angle β relative to the optical axis.

### FIELD

The present disclosure relates to the field of near eye display systems such as head-mounted displays. More specifically, the present disclosure relates to a compact projection system designed for near eye displays (NEDs).

### BACKGROUND

Consumer demands for improved human-computer interfaces have led to an increased interest in high-quality image head-mounted displays (HMDs) or near-eye displays (NED), commonly known as smart glasses. These devices can provide virtual reality (VR) or augmented reality (AR) experiences, enhancing the way users interact with digital content and their surrounding environment.

Consumers are seeking better image quality, immersive experiences, and greater comfort when using HMDs. They expect displays with high resolution, vibrant colors, and minimal distortion to create a realistic and enjoyable viewing experience. Additionally, comfort is a crucial factor since users often wear these devices for extended periods. Consumers desire lightweight, sleek designs that are less obtrusive and more convenient to wear in various scenarios. Smaller devices also offer improved portability, making them easier to carry and use in different environments. As such, there is a growing demand for higher performing yet smaller and more compact HMDs.

A critical element of the near-eye display systems is the projector. In the context of HMDs and NEDs, an image projector is a device that generates and projects visual content onto an intermediate medium (i.e., lightguide) to be delivered to the eye. The goal is to provide the user with the perception of images or videos, often with the illusion of depth or three-dimensionality.

Technology behind projectors for HMDs and NEDs include reflective Spatial Light Modulators (SLMs) such as Liquid Crystal on Silicon (LCoS). Conventionally SLM based projectors require significant volume to transport light from light sources such as LED to the SLM and the modulated light to the lightguide's pupil. This significant volume deterred from the stated goal compactness of the HMD.

Therefore, there is a demand for innovative compact illuminations systems.

### SUMMARY

The present disclosure is directed towards the utilization of a Polarizing Beam Splitter (PBS) structure with a novel design to couple light of a projection system, ensuring enhanced optical performance while minimizing the system size. The inventive concept is especially beneficial in applications involving reflective Spatial Light Modulators (SLMs) such as Liquid Crystal on Silicon (LCoS) technology, where the telecentricity of the optical system and normal incidence of light rays on the SLM are important for proper modulation of light and image formation. Through the innovative design of the PBS structure and the incorporation of additional optical components like prisms, waveguides, mirrors, and polarization rotation devices, the disclosed invention aims to address the challenges associated with conventional voluminous optical systems in NEDs, paving the way for more compact, efficient, and high-performance optical solutions in near eye display technology.

An optical device may include a first and second polarization-selective surfaces, each configured to reflect a first polarization of incident light and transmit a second polarization of incident light orthogonal to the first polarization, the first polarization-selective surface disposed between first and second optical input surfaces at a first angle α relative to an optical axis of the device and the second polarization-selective surface disposed between the first and second optical input surfaces at a second angle β relative to the optical axis, where β is approximately equal to −α.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a schematic diagram of a traditional illumination system used in near-eye displays (NED).

FIG. 2A illustrates an exemplary illumination system including a novel device with two PBS surfaces.

FIGS. 2B and 2C illustrate schematic and exploded views of the novel device of FIG. 2A.

FIG. 2D illustrates a system incorporating the novel device and an LOE or waveguide.

FIG. 3A illustrates another exemplary illumination system including the novel device.

FIG. 3B illustrates a perspective view of the system of FIG. 3A.

FIGS. 3C and 3D show optical simulations illustrating light fills for two different angle fields for the system of FIG. 3A.

FIG. 4 illustrates another exemplary illumination system including the novel device.

FIG. 5 illustrates another exemplary illumination system including the novel device.

### DETAILED DESCRIPTION

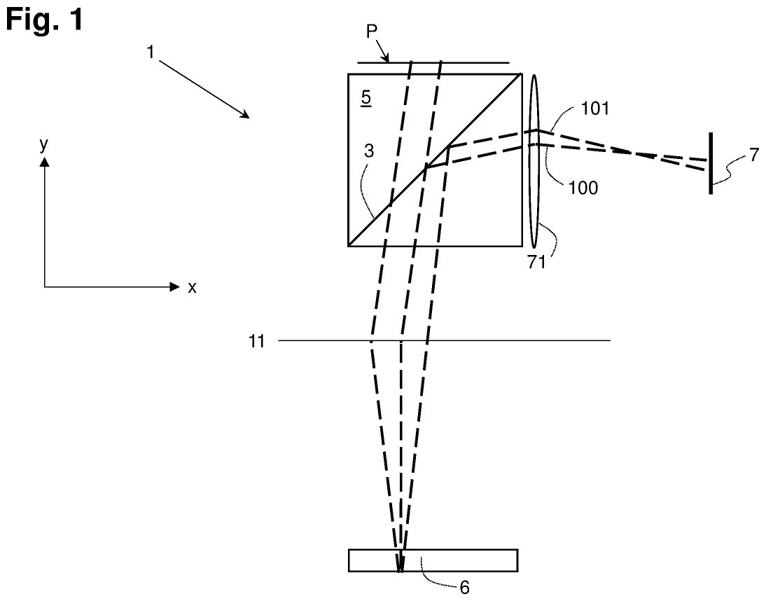

FIG. 1 illustrates a schematic diagram of a traditional illumination system 1 used in near-eye displays (NED). System 1 includes a reflective Spatial Light Modulator (SLM) 6, such as Liquid Crystal on Silicon (LCoS), along with a prism or polarizing beam splitter (PBS) 5 located close to the SLM 6. Commonly, the light meant for illumination is directed near the exit pupil P of system 1, as depicted in FIG. 1. The pupil P, being close to PBS 5, usually works most efficiently in a telecentric optical setup, meaning when the chief ray from each angle field strikes the SLM 6 at a normal angle, as shown in FIG. 1. Normal in this context corresponds to an angle of 90°+/−10% (i.e., 81° to 99°) relative to the surface being struck.

Generally, a light source such as an LED or multi-LED 7 is positioned ahead of some optics and its light is directed by the PBS prism 5 into a telecentric optical system that makes the LCoS image clear. For simplicity, FIG. 1 only displays two rays emitted from source 7, which are bent by lens 71 before entering PBS prism 5. In one embodiment, the LED light is S polarized and gets reflected by the surface 3 of PBS 5. Ray 100, being a chief ray, strikes the SLM 6 at a normal angle (for purposes of illustration, chief rays such as ray 100 are shown slightly off normal angle to not overlap themselves in the illustrations) and is reflected towards the center of pupil P through the PBS 5. In the illustrated embodiment of FIG. 1, optical lenses of system 1 are represented by a simple lens 11, placed within a 2F system (meaning the distance in the y direction from pupil P to lens 11 equals the distance from lens 11 to the SLM 6 plane). Ray 101, not being a chief ray, is reflected differently around ray 100 post its polarization being altered by SLM 6 and reaches pupil P through the PBS 5.

In a system such as system 1 of FIG. 1, the PBS 5 needs to be sufficiently large (in both x and y dimensions) to allow substantially all light from LED 7 to strike surface 3, without being reflected off any other surface of PBS 5. This necessity for a large PBS 5 can lead to an undesirably bulkier optical system 1, which might also potentially hinder its performance.

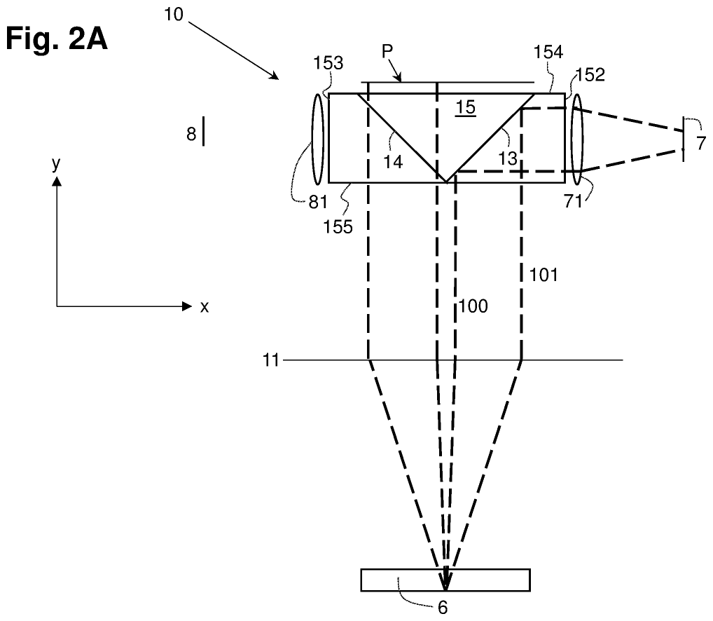

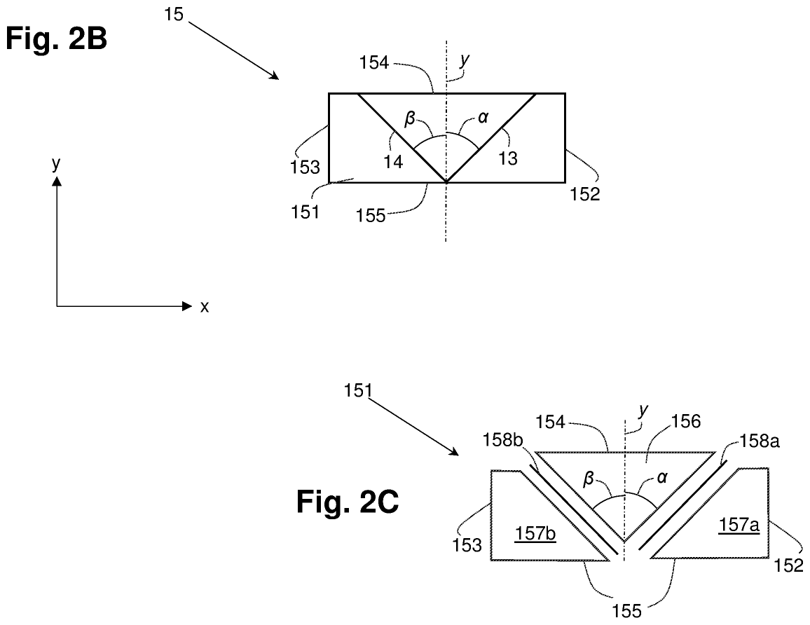

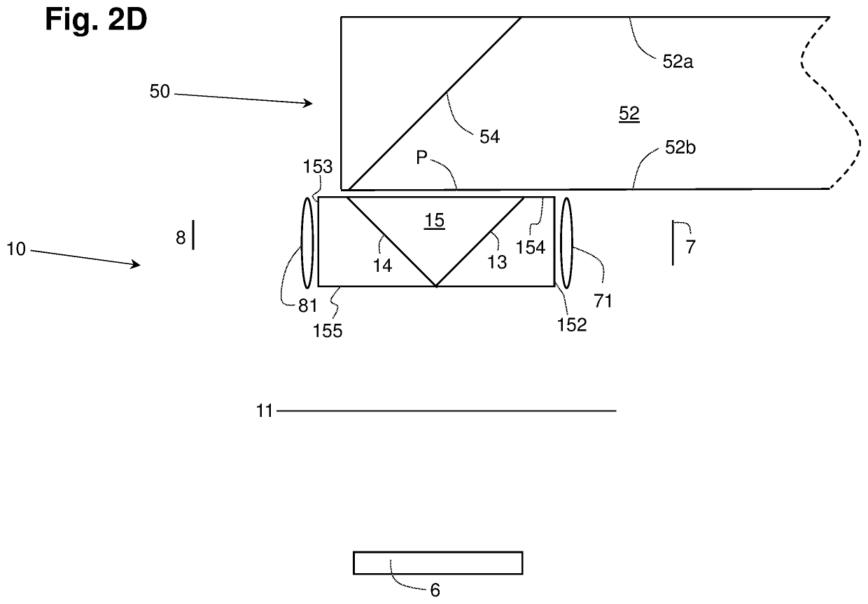

FIG. 2A illustrates a new system 10 including a novel structure 15 with two PBS surfaces 13 and 14. The structure 15 may have significantly less thickness (y dimension) compared to the PBS cube 5 of FIG. 1, which allows for a system 10 that is smaller than the system 1 of FIG. 1.

FIG. 2B illustrates a schematic diagram of the novel structure 15.

The optical device 15 includes a device body 151 having a first optical input surface 152 disposed at a first end of the device body 151 and a second optical input surface 153 disposed at a second end of the device body opposite the first end. The device body 151 also has a first optical output surface 154 disposed at a first side of the device body and a second optical output surface 155 disposed at a second side of the device body opposite the first side. Device 15 has an optical axis y orthogonal to the first optical output surface 154 and the second optical output surface 155.

The optical device 15 also includes a first polarization-selective surface 13 that reflects a first polarization (e.g., S or P polarization) of incident light and transmits a second polarization (e.g., P or S polarization) of incident light orthogonal to the first polarization. The first polarization-selective surface 13 is disposed between the first and second optical input surfaces 152, 153 at a first angle α relative to the optical axis y such that light entering the optical device 15 through the first optical input surface 152 is incident on the first polarization-selective surface 13 and the first polarization (e.g., S or P polarization) of incident light is reflected out of the optical device 15 through the second optical output surface 155.

The optical device 15 also includes a second polarization-selective surface 14 that reflects the first polarization (e.g., S or P polarization) of incident light and transmit the second polarization (e.g., P or S polarization) of incident light orthogonal to the first polarization. The second polarization-selective surface 14 is disposed between the first and second optical input surfaces 152, 153 at a second angle β relative to the optical axis y such that light entering the optical device 15 through the second optical input surface 153 is incident on the second polarization-selective surface 14 and the first polarization (e.g., S or P polarization) of incident light is reflected out of the optical device 15 through the second optical output surface 155.

In the optical device 15 of FIGS. 2A and 2B (as well as other optical devices 15a and 15b disclosed herein) β is approximately equal to −α to maintain relative symmetry. Approximately in this context means within 10%. That is, the difference between β and −α is +/−10%. The angle α may be in a range of between 30° and 75° relative to the optical axis y and the angle β may be in a range of between −30° and −75° relative to the optical axis y. In one specific example, the first angle α is 45° and the second angle β is −45° relative to the optical axis y. In another specific example, the first angle α is 60° and the second angle β is −60° relative to the optical axis y.

FIG. 2C illustrates an exploded view of device body 151. Device body 151 may be formed by adjoining at least three optical portions 156, 157a, 157b, each of the at least three optical portions made of an optically transparent material.

One or more polarization-selective coatings or foils 158a, 158b may be disposed between the at least three portions 156, 157a, 157b. That is, adjoining surfaces of the optical portions 156, 157a, 157b may be coated with one or more polarization-selective coatings configured to reflect a first polarization (e.g., S or P polarization) of incident light and transmit a second polarization (e.g., P or S polarization) of incident light orthogonal to the first polarization such that the adjoining surfaces, when adjoined, form the first polarization-selective surface 13 and the second polarization-selective surface 14.

Returning to FIG. 2A, system 10 includes two light sources 7, 8, each with its own set of optics 71, 81. SLM 6 is disposed adjacent to the second optical output surface 155 (i.e., SLM 6 is disposed on the second optical output surface side of the device 15). The first light source 7, 71 is optically coupled to the first optical input surface 152 and the second light source 8, 81 is optically coupled to the second optical input surface 153. A telecentric lens configuration 11 is disposed optically between the SLM 6 and the second optical output surface 155. Substantially all light chief rays strike the SLM 6 at a normal angle. Ray 100, being a chief ray, strikes the SLM 6 at a normal angle (for purposes of illustration, the ray 100 is shown slightly off normal angle to not overlap itself in the diagram) and is reflected by SLM 6 at a normal angle towards pupil P, its polarization being rotated by SLM 6. Ray 101, not being a chief ray, is reflected by SLM 6 differently (i.e., not at a normal angle) around ray 100 and reaches pupil P, post its polarization being altered by SLM 6. This setup aims to make the SLM image appear at an infinite distance, a common goal for NED systems using a waveguide.

In operation, light from the first light source 7, 71 enters through the first optical input surface 152 to be incident on the first polarization-selective surface 13. The first polarization (e.g., S or P polarization) light is reflected out of the optical device 15 through the second optical output surface 155, transmitted through the telecentric lens configuration 11 such that chief rays of angle fields impinge on the SLM 6 normally, reflected by the SLM 6 in the second polarization (e.g., P or S polarization), transmitted through the telecentric lens configuration 11 to enter the optical device 15 through the second optical output surface 155, transmitted through the second polarization-selective surface 14, and outputted out of the optical device 15 through the first optical output surface 154 to the pupil P.

FIG. 2A illustrates only illumination corresponding to the first light source 7, 71, but the system 10 operates largely symmetrically. That is, light from the second light source 8, 81 enters through the second optical input surface 153 to be incident on the second polarization-selective surface 14. The first polarization (e.g., S or P polarization) light is reflected out of the optical device 15 through the second optical output surface 155, transmitted through the telecentric lens configuration 11 such that chief rays of angle fields impinge on the SLM 6 normally, reflected by the SLM 6 in the second polarization (e.g., P or S polarization), transmitted through the telecentric lens configuration 11 to enter the optical device 15 through the second optical output surface 155, transmitted through the first polarization-selective surface 13, and outputted out of the optical device 15 through the first optical output surface 154 to the pupil P.

FIG. 2D illustrates the system 10 assembled to project light into a light-guide optical element (LOE) 50. Examples of LOE 50 are described in significant detail in, for example, U.S. Pat. Nos. 7,643,214 and 7,724,442 to Amitai. LOE 50 includes a light-transmitting substrate 52 having first and second major surfaces 52a, 52b parallel to each other. LOE 50 also includes a surface 54 that is non-parallel to the first and second major surfaces 52a, 52b. The surface 54 couples light from the system 10 incident thereupon into the light-transmitting substrate 52. Width of the surface 54 facing the system 10 and specifically the output of the device 15 corresponds to the pupil P. The surface 54, may be reflective (e.g., mirror), refractive, or diffractive and, thus, may reflect, refract, or diffract light and thereby trap the light between the first and second major surfaces 52a, 52b by total internal reflection. The LOE 50 may also include one or more light output elements (not shown) such as partially reflecting surfaces that are non-parallel to the first and second major surfaces 52a, 52b and couple the light out of the substrate 52. In one embodiment, element 50, instead of an LOE, may be a different polarization sensitive near eye display waveguide (e.g., diffractive, reflective, holographic, or refractive waveguide).

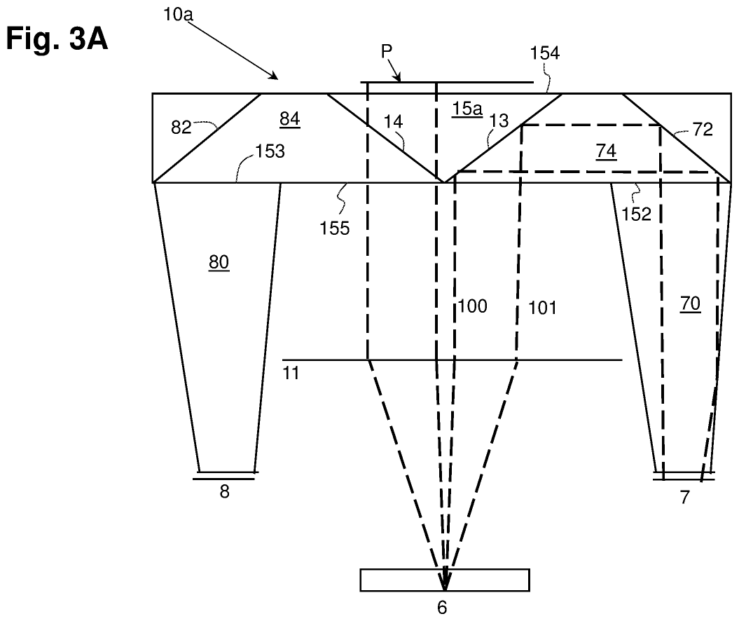

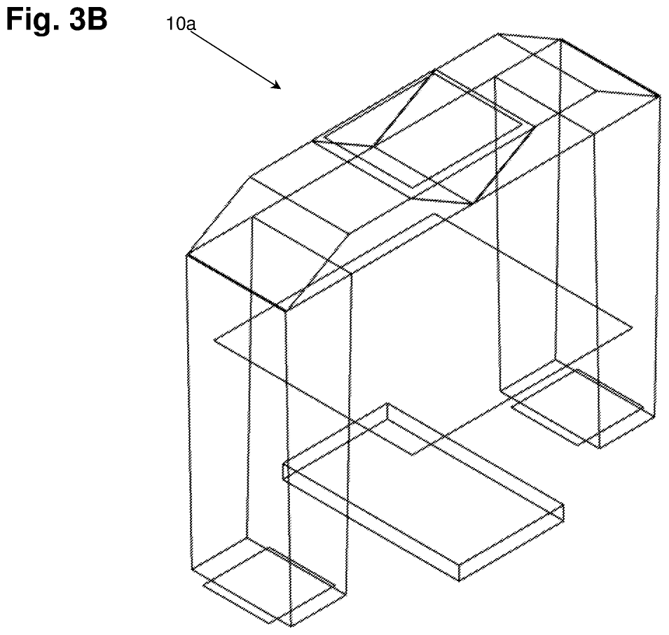

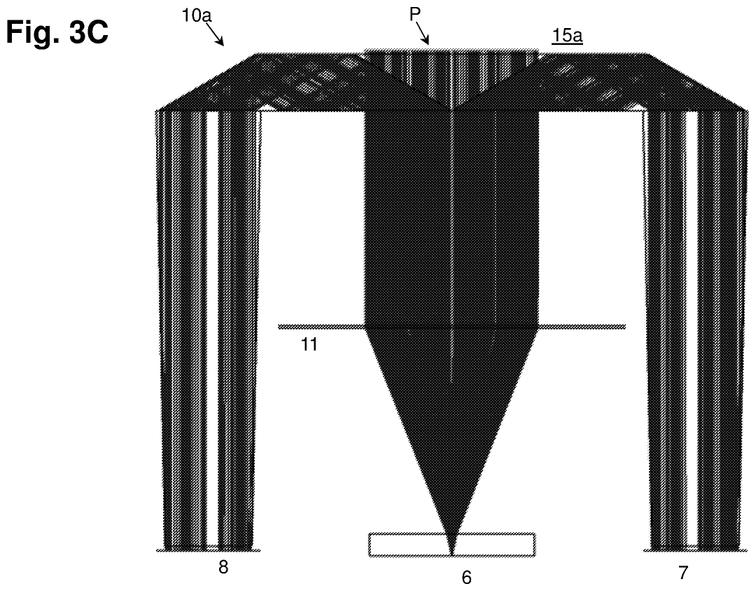

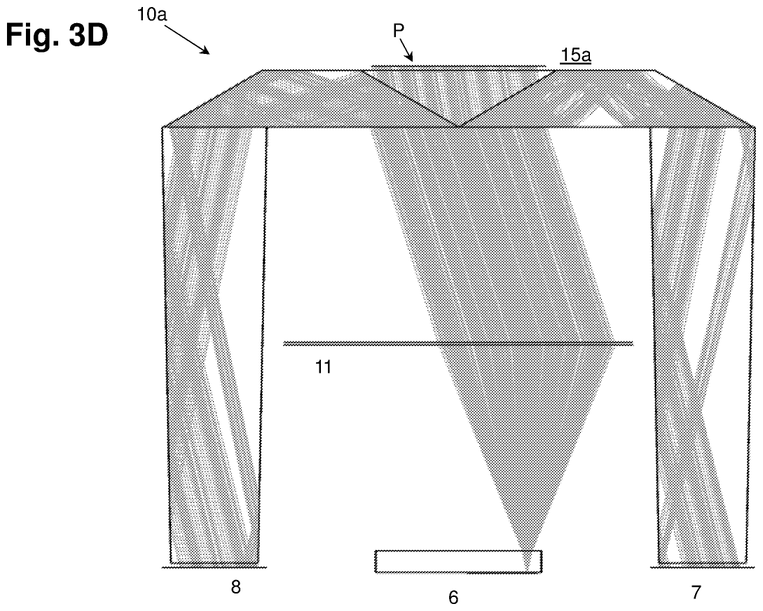

FIGS. 3A-3D illustrate a novel system 10a, similar to the system 10 of FIG. 2, including a novel structure 15a similar to the structure 15 of FIG. 2 and additional components. System 10a uses prisms, mirrors, and waveguides to channel the light from the light sources to the novel optical device.

As shown in FIG. 3A, system 10a includes the SLM 6 disposed adjacent (i.e., on the side of) the second optical output surface 155, a first light source 7 optically coupled by a prism 70 to the first optical input surface 152 and a second light source 8 optically coupled by a prism 80 to the second optical input surface 153. System 10a also includes mirrors 72, 82 that reflect the light to waveguides 74, 84 that conduit the light to the PBS surfaces 13, 14. System 10a also includes a telecentric lens configuration 11 disposed optically between the SLM 6 and the second optical output surface 155.

In operation, light from the first light source 7 travels through the first prism 70 to be incident on the first mirror 72, reflected to travel through the waveguide 74 to the first polarization-selective surface 13. The first polarization (e.g., S or P polarization) light is reflected out of the optical device 15a through the second optical output surface 155, transmitted through the telecentric lens configuration 11 such that chief rays of angle fields impinge on the SLM 6 normally, reflected by the SLM 6 in the second polarization (e.g., P or S polarization), transmitted through the telecentric lens configuration 11 to enter the optical device 15a through the second optical output surface 155, transmitted through the second polarization-selective surface 14, and outputted out of the optical device 15a through the first optical output surface 154 to the pupil P.

For purposes of illustration, only light corresponding to the LED 7 is shown in FIG. 3. However, system 10a operates largely symmetrically. Light from the second light source 8 travels through the second prism 80 to be incident on the second mirror 82, reflected to travel through the waveguide 84 to the second polarization-selective surface 14. The first polarization (e.g., S or P polarization) light is reflected out of the optical device 15a through the second optical output surface 155, transmitted through the telecentric lens configuration 11 such that chief rays of angle fields impinge on the SLM 6 normally, reflected by the SLM 6 in the second polarization (e.g., P or S polarization), transmitted through the telecentric lens configuration 11 to enter the optical device 15a through the second optical output surface 155, transmitted through the first polarization-selective surface 13, and outputted out of the optical device 15a through the first optical output surface 154 to the pupil P.

FIG. 3B illustrates a perspective view of system 10a.

FIGS. 3C and 3D show optical simulations illustrating how light fills the system 10a and specifically the pupil P for two fields. FIG. 3C shows an optical simulation for the filling of the pupil P by the central field. FIG. 3D shows an optical simulation for the filling of the pupil P by a non-central field. In each case, the chief ray strikes the SLM 6 at a normal angle of incidence.

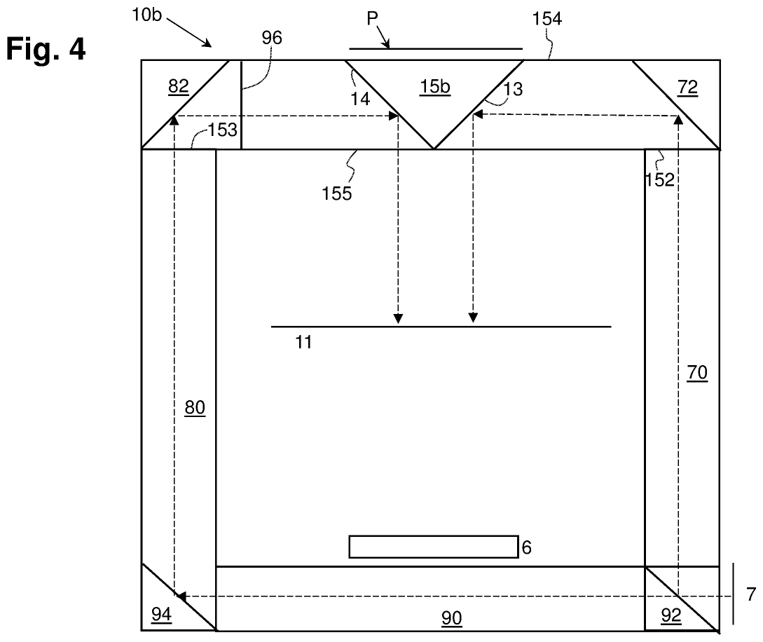

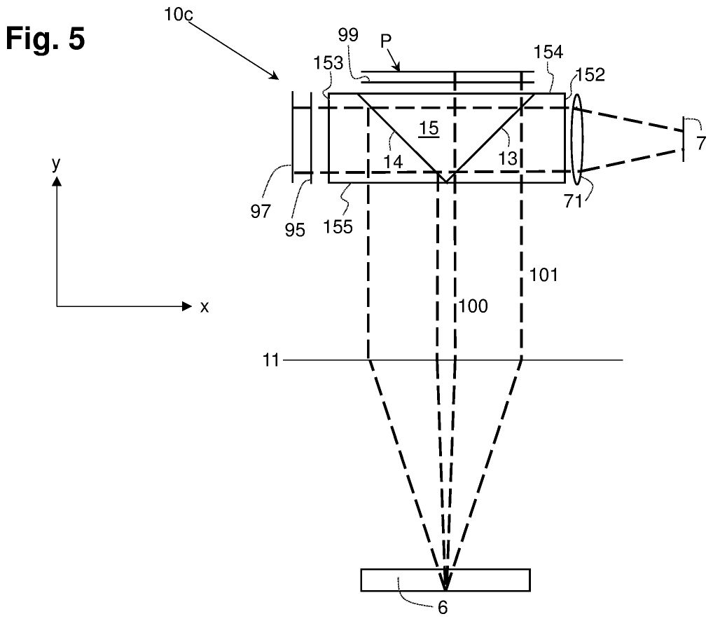

FIGS. 4 and 5 illustrate novel systems 10b and 10c, similar to systems 10 and 10a of FIGS. 2A and 3A, including a novel structure 15b (similar to structures 15 and 15a) and novel structure 15, respectively. In contrast to the previous embodiments in which the light source was generally (but not exclusively) polarized, in the embodiments of FIGS. 4 and 5, the light source 7 is not polarized.

In system 10b of FIG. 4, light from light source 7 is directed to impinge on PBS 92 and divided between two polarizations (e.g., S and P polarizations).

PBS 92 reflects the first polarization light (e.g., S or P polarization) from the light source 7, which travels through the first waveguide 70 to be incident on the first mirror 72 and reflected to the first polarization-selective surface 13. Surface 13 reflects the first polarization light out of the optical device 15b through the second optical output surface 155 to be transmitted through the telecentric lens configuration 11 such that chief rays of angle fields impinge on the SLM 6 normally. SLM 6 reflects the light in the second polarization (e.g., P or S polarization) to be transmitted through the telecentric lens configuration 11 to enter the optical device 15b through the second optical output surface 155, transmitted through the second polarization-selective surface 14, and outputted out of the optical device 15b through the first optical output surface 154 to the pupil P.

At the same time, PBS 92 transmits second polarization (e.g., P or S polarization) light from the light source 7, which travels through an optical path including traveling through third waveguide 90, being reflected by third mirror 94, traveling through second waveguide 80 to be incident on second mirror 82, and being reflected to the second polarization-selective surface 14. A polarization rotation device 96 is disposed somewhere along the optical path to rotate polarization of the second polarization light (e.g., P or S polarization) to the first polarization (e.g., S or P polarization) along the optical path such that the second polarization-selective surface 14 reflects the first polarization light (e.g., S or P polarization) out of the optical device 15b through the second optical output surface 155 to be transmitted through the telecentric lens configuration 11 such that chief rays of angle fields impinge on the SLM 6 normally. SLM 6 reflects the light in the second polarization (e.g., P or S polarization) to be transmitted through the telecentric lens configuration 11 to enter the optical device 15b through the second optical output surface 155, transmitted through the first polarization-selective surface 13, and outputted out of the optical device 15b through the first optical output surface 154 to the pupil P.

In system 10c of FIG. 5, unpolarized light from light source 7, 71 enters through the first optical input surface 152 to be incident on the first polarization-selective surface 13. First polarization (e.g., S or P polarization) light is reflected by the first polarization-selective surface 13 out of the optical device 15 through the second optical output surface 155, transmitted through the telecentric lens configuration 11 such that chief rays of angle fields impinge on the SLM 6 normally. SLM 6 reflects the light in the second polarization (e.g., P or S polarization) to be transmitted through the telecentric lens configuration 11 to enter the optical device 15 through the second optical output surface 155, transmitted through the second polarization-selective surface 14, and outputted out of the optical device 15 through the first optical output surface 154 to the pupil P. As can be appreciated from the above description, treatment of first polarization light is identical to that of system 10 of FIG. 2 and, therefore, not shown in FIG. 5.

Second polarization (e.g., P or S polarization) light from the light source 7, however, is transmitted by the first polarization-selective surface 13 and the second polarization-selective surface 14, exits through the second optical input surface 153, passes through a quarter-wave plate 95 to rotate polarization a quarter wave, is reflected by a mirror 97, passes through the quarter-wave plate 95 a second time to rotate polarization an additional quarter wave to the first polarization (e.g., S or P polarization). First polarization (e.g., S or P polarization) light reenters the device 15 through the second optical input surface 153 to be incident on the second polarization-selective surface 14, which reflects the first polarization light out of the optical device 15 through the second optical output surface 155 to be transmitted through the telecentric lens configuration 11 such that chief rays of angle fields impinge on the SLM 6 normally. SLM 6 reflects the light in the second polarization (e.g., P or S polarization) to be transmitted through the telecentric lens configuration 11 to enter the optical device 15 through the second optical output surface 155, transmitted through the first polarization-selective surface 13, and outputted out of the optical device 15 through the first optical output surface 154 to the pupil P.

In the illustrated embodiment, a polarizer 99 may be introduced so as to prevent S polarized light that was reflected directly upwards by polarization-selective surfaces 13, 14 to degrade the system contrast.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. (canceled)

2. The optical system of claim 5 wherein:
the light source includes a first light source optically coupled to the first optical input surface and a second light source optically coupled to the second optical input surface;
the telecentric lens configuration is disposed optically between the SLM and the second optical output surface such that:
light from the first light source enters through the first optical input surface to be incident on the first polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
light from the second light source enters through the second optical input surface to be incident on the second polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

3. The optical system of claim 5, comprising:
a first prism and a second prism;
the mirror includes a first mirror optically disposed between the first polarization-selective surface and the first prism, and a second mirror optically disposed between the second polarization-selective surface and the second prism;
the light source includes a first light source optically coupled to the first prism and a second light source optically coupled to the second prism;
the telecentric lens configuration is disposed optically between the SLM and the second optical output surface such that:
light from the first light source travels through the first prism to be incident on the first mirror, reflected to the first polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
light from the second light source travels through the second prism to be incident on the second mirror, reflected to the second polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

4. An The optical system of claim 5, comprising:
a first waveguide and a second waveguide;
the mirror includes a first mirror optically disposed between the first polarization-selective surface and the first waveguide, and a second mirror optically disposed between the second polarization-selective surface and the second waveguide;
a third waveguide and third mirror optically coupled to the second waveguide;
a polarizing beam splitter (PBS) optically coupled to the first waveguide and the third waveguide;
a polarization rotation device optically coupled to the third waveguide;
the light source optically coupled to the PBS;
the telecentric lens configuration is disposed optically between the SLM and the second optical output surface such that:
first polarization light from the light source is reflected by the PBS, travels through the first waveguide to be incident on the first mirror, reflected to the first polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
second polarization light from the light source is transmitted by the PBS to travel through an optical path including traveling through the third waveguide, being reflected by the third mirror, traveling through the second waveguide to be incident on the second mirror, being reflected to the second polarization-selective surface, the polarization rotation device rotating polarization of the second polarization light to the first polarization along the optical path such that the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

5. An optical system comprising:
an optical device comprising:
a device body having a first optical input surface disposed at a first end of the device body and a second optical input surface disposed at a second end of the device body opposite the first end, a first optical output surface disposed at a first side of the device body and a second optical output surface disposed at a second side of the device body opposite the first side, an optical axis of the optical device orthogonal to the first optical output surface and the second optical output surface;
a first polarization-selective surface configured to reflect a first polarization of incident light and transmit a second polarization of incident light orthogonal to the first polarization, the first polarization-selective surface disposed between the first and second optical input surfaces at a first angle α relative to the optical axis such that light entering the optical device through the first optical input surface is incident on the first polarization-selective surface and the first polarization of incident light is reflected out of the optical device through the second optical output surface;
a second polarization-selective surface configured to reflect the first polarization of incident light and transmit the second polarization of incident light orthogonal to the first polarization, the second polarization-selective surface disposed between the first and second optical input surfaces at a second angle β relative to the optical axis such that light entering the optical device through the second optical input surface is incident on the second polarization-selective surface and the first polarization of incident light is reflected out of the optical device through the second optical output surface, wherein β is approximately equal to −α;
a spatial light modulator (SLM) disposed on a second optical output surface side of the optical device;
a light source optically coupled to the first optical input surface;
a mirror disposed adjacent the second optical input surface;
a quarter-wave plate optically coupled between the mirror and the second optical input surface;
a telecentric lens configuration disposed optically between the SLM and the second optical output surface such that:
light from the light source enters through the first optical input surface to be incident on the first polarization-selective surface,
wherein first polarization light from the light source is reflected by the first polarization-selective surface out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
wherein second polarization light from the light source is transmitted by the first polarization-selective surface and the second polarization-selective surface, exits through the second optical input surface, passes the quarter-wave plate to rotate polarization a quarter wave, is reflected by the mirror, passes the quarter-wave plate a second time to rotate polarization an additional quarter wave to the first polarization, reenters through the second optical input surface to be incident on the second polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

6. The optical system of claim 5, wherein the first angle α is in a range of between 30° and 75° relative to the optical axis or wherein the first angle α is one of 45° or 60° relative to the optical axis.

7. The optical system of claim 5, wherein the system includes a light-guide optical element (LOE) or another polarization sensitive near eye display waveguide into which light from the optical device is projected.

8. (canceled)

9. The optical system of claim 12,
the light source includes a first light source optically coupled to the first optical input surface and a second light source optically coupled to the second optical input surface;
wherein the telecentric lens configuration is disposed optically between the SLM and the second optical output surface such that:
light from the first light source enters through the first optical input surface to be incident on the first polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
light from the second light source enters through the second optical input surface to be incident on the second polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

10. The optical system of claim 12, comprising:
a first prism and a second prism;
the mirror includes a first mirror optically disposed between the first polarization-selective surface and the first prism, and a second mirror optically disposed between the second polarization-selective surface and the second prism;
the light source includes a first light source optically coupled to the first prism and a second light source optically coupled to the second prism;
the telecentric lens configuration disposed optically between the SLM and the second optical output surface such that:
light from the first light source travels through the first prism to be incident on the first mirror, reflected to the first polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
light from the second light source travels through the second prism to be incident on the second mirror, reflected to the second polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

11. The optical system of claim 12, comprising:
a first waveguide and a second waveguide;
the mirror includes a first mirror optically disposed between the first polarization-selective surface and the first waveguide, and a second mirror optically disposed between the second polarization-selective surface and the second waveguide;
a third waveguide and third mirror optically coupled to the second waveguide;
a polarizing beam splitter (PBS) optically coupled to the first waveguide and the third waveguide;
a polarization rotation device optically coupled to the third waveguide;
the light source optically coupled to the PBS;
the telecentric lens configuration is disposed optically between the SLM and the second optical output surface such that:
first polarization light from the light source is reflected by the PBS, travels through the first waveguide to be incident on the first mirror, reflected to the first polarization-selective surface, the first polarization light being reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
second polarization light from the light source is transmitted by the PBS to travel through an optical path including traveling through the third waveguide, being reflected by the third mirror, traveling through the second waveguide to be incident on the second mirror, being reflected to the second polarization-selective surface, the polarization rotation device rotating polarization of the second polarization light to the first polarization along the optical path such that the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

12. An optical system comprising:
an optical device comprising:
a device body formed by adjoining at least three optical portions, each of the at least three optical portions made of an optically transparent material, the device body having a first optical input surface disposed at a first end of the device body and a second optical input surface disposed at a second end of the device body opposite the first end, a first optical output surface disposed at a first side of the device body and a second optical output surface disposed at a second side of the device body opposite the first side, an optical axis of the optical device orthogonal to the first optical output surface and the second optical output surface;
one or more polarization-selective coatings or foils disposed between the at least three portions, wherein the one or more polarization-selective coatings or foils are configured to reflect a first polarization of incident light and transmit a second polarization of incident light orthogonal to the first polarization such that adjoining surfaces of the at least three optical portions form a first polarization-selective surface and a second polarization-selective surface;
the first polarization-selective surface disposed between the first and second optical input surfaces at a first angle α relative to the optical axis such that the first polarization-selective surface reflects the first polarization of incident light out of the optical device through the second optical output surface; and
the second polarization-selective surface disposed between the first and second optical input surfaces at a second angle β relative to the optical axis such that the second polarization-selective surface reflects the first polarization of incident light out of the optical device through the second optical output surface, wherein β is approximately equal to −α;
a spatial light modulator (SLM) disposed on a second optical output surface side of the optical device;
a light source optically coupled to the first optical input surface;
a mirror disposed adjacent the second optical input surface;
a quarter-wave plate optically coupled between the mirror and the second optical input surface;
a telecentric lens configuration disposed optically between the SLM and the second optical output surface such that:
light from the light source enters through the first optical input surface to be incident on the first polarization-selective surface,
wherein first polarization light from the light source is reflected by the first polarization-selective surface out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the second polarization-selective surface, and outputted out of the optical device through the first optical output surface; and
wherein second polarization light from the light source is transmitted by the first polarization-selective surface and the second polarization-selective surface, exits through the second optical input surface, passes the quarter-wave plate to rotate polarization a quarter wave, is reflected by the mirror, passes the quarter-wave plate a second time to rotate polarization an additional quarter wave to the first polarization, reenters through the second optical input surface to be incident on the second polarization-selective surface, the first polarization light is reflected out of the optical device through the second optical output surface, transmitted through the telecentric lens configuration such that chief rays of angle fields impinge on the SLM normally, reflected by the SLM in the second polarization, transmitted through the telecentric lens configuration to enter the optical device through the second optical output surface, transmitted through the first polarization-selective surface, and outputted out of the optical device through the first optical output surface.

13. The optical system of claim 12, wherein the first angle α is a range of between 30° and 75° relative to the optical axis.

14. The optical system of claim 12, wherein the first angle α is one of 45° or 60° relative to the optical axis.

15. A method for an optical device, comprising:
emitting light from one or more light sources;
directing the emitted light towards first and second beam splitter surfaces of the optical device;
reflecting first polarization light by the first and second beam splitter surfaces such that the first polarization light impinges on a spatial light modulator (SLM) at a normal incidence;
modulating the first polarization light using the SLM to form an image;
reflecting by the SLM image light in a second polarization orthogonal to the first polarization; and
transmitting the second polarization light through the first and second beam splitter surfaces to be coupled out of the optical device;
wherein the reflecting the first polarization light by the first and second beam splitter surfaces such that the first polarization light impinges on the SLM at the normal incidence includes:
transmitting of the second polarization light by the first beam splitter surface and the second beam splitter surface;
passing the second polarization light through a quarter-wave plate to rotate polarization a quarter wave;
reflecting the quarter wave rotated light;
passing the quarter wave rotated light through the quarter-wave plate a second time to rotate polarization an additional quarter wave to the first polarization; and
reflecting of the first polarization light by the second beam splitter surface towards the SLM.

16. (canceled)

17. The method of claim 15, wherein the directing the emitted light towards the first and the second beam splitter surfaces of the optical device includes:
guiding light from a first light source, from the one or more light sources, through a first waveguide;
reflecting the first light source light to the first beam splitter surface;
guiding light from a second light source, from the one or more light sources, through a second waveguide; and
reflecting the second light source light to the second beam splitter surface.

18. The method of claim 15, wherein the directing the emitted light towards the first and the second beam splitter surfaces of the optical device includes:
splitting the emitted light by a third beam splitter surface into first polarization light and second polarization light;
reflecting by the third beam splitter surface of the first polarization light;
guiding the first polarization guide to be incident on a first mirror;
reflecting the first polarization light towards the first beam splitter surface;
transmitting by the third beam splitter surface of the second polarization light;
guiding the second polarization guide to be incident on a second mirror;
rotating polarization of the second polarization light to the first polarization; and
reflecting the first polarization light towards the second beam splitter surface.

19. The method of claim 15, wherein the directing the emitted light towards the first and the second beam splitter surfaces of the optical device includes:
splitting the emitted light by a third beam splitter surface into first polarization light and second polarization light;
reflecting by the third beam splitter surface of the first polarization light;
guiding the first polarization guide to be incident on a first mirror;
reflecting the first polarization light towards the first beam splitter surface;
transmitting by the third beam splitter surface of the second polarization light;
rotating polarization of the second polarization light to the first polarization;
guiding the first polarization guide to be incident on a second mirror; and
reflecting the first polarization light towards the second beam splitter surface.

20. (canceled)
